(19) United States
(12) Patent Application Publication
(10) Pub. No.: US 2011/0195376 A1
(43) Pub. Date: Aug. 11, 2011

(54) MULTIPURPOSE THERAPEUTIC MOUTHPIECE ASSEMBLY

(76) Inventor: James P. Boyd, SR., Rancho Santa Fe, CA (US)

(21) Appl. No.: 13/024,180

(22) Filed: Feb. 9, 2011

Related U.S. Application Data
(60) Provisional application No. 61/302,899, filed on Feb. 9, 2010.
(60) Provisional application No. 61/387,548, filed on Sep. 29, 2010.

(51) Int. Cl. A61C 19/06

(52) U.S. Cl. 433/140

(57) ABSTRACT

An multipurpose mouthpiece assembly is disclosed for use in diagnosing and treating a variety of termporomandibular disorders. The assembly can include both a maxillary appliance and a mandibular appliance that are optionally configurable to function as a discluder, for diagnosing and treating wearers suffering from bruxism, tension headaches, and common migraine headaches, by preventing contact between opposing canine and posterior teeth and thereby reducing the intensity of clenching of the wearer's temporalis muscles. Alternatively, the two appliances are optionally configurable for use as a mandibular advancement device, for diagnosing and treating wearers suffering from obstructive sleep apnea by preventing excessive retrusion of the wearer's mandible. Alternatively, either the maxillary appliance or the mandibular appliance can be used individually to protect the teeth from nocturnal asymptomatic teeth grinding. In all cases, the appliance(s) can be readily adjusted to accommodate wearers whose maxillary and mandibular arches have a variety of sizes and shapes.

### CROSS-REFERENCE TO RELATED APPLICATIONS

Priority is claimed to U.S. Provisional Patent Application No. 61/302,899, filed Feb. 9, 2010, and entitled “A Multi-Diagnostic, Multi-Therapeutic One-Step Mouthpiece System,” and U.S. Provisional Patent Application No. 61/387,548, filed Sep. 29, 2010, and entitled “Using Polycaprolactone to Adapt a Dental-Retained Flat Plane Mouthpiece and Method of Retention.”

### BACKGROUND OF THE INVENTION

1. Field of the Invention

This invention relates generally to intraoral appliances and, more particularly, to a multipurpose therapeutic mouthpiece assembly that is configurable for use in diagnosing and therapeutically treating a variety of disorders, including bruxism, tension and common migraine headaches, obstructive sleep apnea, and other temporomandibular disorders.

2. Description of the Prior Art

Tension and muscle contraction headaches affect many people every day. The headaches are often recurring and, without effective treatment, can become very painful, restricting an individual's ability to think clearly and function effectively. The discomfort associated with tension and muscle contraction headaches is usually due to pain from strained and fatigued muscles of the head. The majority of the muscles of the head are not sufficiently strong to elicit the type of pain and discomfort associated with tension and muscle contraction headaches. However, that is not the case with the temporalis muscle, which is located on the side of the skull and extends from just behind the eye to just behind the ear, and which is an extremely powerful muscle that functions to close or elevate the jaw.

Under normal circumstances, the temporalis muscle should not exert a large static force by contracting isometrically, except possibly during normal chewing. Inappropriate isometric contraction of the temporalis muscle is commonly known as “clenching” and clinically known as myofascial dysfunction. Unfortunately, myofascial dysfunction is particularly difficult to detect or diagnose, because the act of clenching is a somewhat motionless act that is commonly done while a person is concentrating on another topic, or while sleeping.

As the muscular contraction condition of “clenching” continues, the temporalis muscle becomes fatigued and susceptible to spasm and cramping. The pain from spasming and cramping temporalis fibers is severe, and it usually is diagnosed as a common migraine. Headache sufferers who seek the assistance of a physician frequently are treated with muscle relaxants, analgesics, and physical therapy for the muscle fatigue. However, medications and therapy require continual treatment, and they treat only the symptoms of the underlying problem, not the problem itself.

Headache sufferers who seek the assistance of a dentist, on the other hand, frequently are diagnosed with a temporomandibular disorder and treated with an intraoral “jaw-positioning” appliance. One such appliance is disclosed in U.S. Pat. No. 6,666,212, issued in the name of James P. Boyd, Sr. and entitled “Intraoral Discluder Device and Method for Preventing Migraine and Tension Headaches and Temporomandibular Disorders.” The appliance has two primary components, including (1) a semi-custom tray sized to fit over the wearer's maxillary or mandibular incisors, and (2) a quantity of an adaptable material disposed within the tray and adapted to conform to the shape of the incisors and thereby assist in retaining the appliance in its prescribed position. A third component has the form of protrusion, or platform, attached to the tray, for engagement with the opposing incisors. The protrusion is sized and configured to prevent contact between opposing upper and lower teeth, including the posterior and canine teeth and to thereby reduce the intensity of clenching of the temporalis muscles. The platform projects both forward and rearward of the incisors by a sufficient distance to ensure that it engages the opposing incisors when the mandible is in either a fully retrusive position or a fully protrusive position.

Some of these same headache sufferers, as well as others, suffer from mild to moderate obstructive sleep apnea. Typically, this occurs when the mandible moves to its fully retrusive position, obstructing the sufferer's airway and sometimes closing it off entirely. In the past, this disorder frequently has been treated using an intraoral appliance that blocks the mandible from moving to its fully retrusive position. Although such appliances frequently are effective at minimizing the occurrence of obstructive sleep apnea, the appliances generally are incompatible with the intraoral discluder appliance described above. Generally, separate appliances must be used to treat each disorder.

Further, the intraoral appliances described above for treating bruxism and migraine headaches, as well as for treating obstructive sleep apnea, are configured for only a limited range of arch widths and lengths. The dental practitioner must maintain stocks of multiple sizes of each such appliance to ensure that at least one of them will be appropriate for each sufferer. This has led to unnecessary expense.

It should be apparent from the foregoing description that there is need for a more universal intraoral appliance that can be selectively configured to diagnose and treat not only bruxism, tension headaches, common migraine headaches, and other temporomandibular disorders, but also mild to moderate obstructive sleep apnea. It also will be apparent that there is a need for such an appliance to be adaptable for use by wearers having a wide variety of arch shapes and sizes. The present invention satisfies these needs and provides further related advantages.

### SUMMARY OF THE INVENTION

The present invention is embodied in a mouthpiece assembly that can be selectively configured to diagnose and treat a variety of temporomandibular disorders, including bruxism, tension headaches, and common migraine headaches, as well as mild to moderate obstructive sleep apnea. The assembly includes (1) a prefabricated maxillary tray defining a channel sized and configured to fit over at least the maxillary incisors of a wearer; (2) a quantity of adaptable material disposed within the tray's channel and adapted to conform to the shape of the wearer's maxillary incisors, to assist in retaining the assembly within the wearer's mouth; and (3) an L-shaped hook having a long section and a short section projecting laterally from one end of the long section. The long section of the L-shaped hook is configured to be optionally secured to the surface of the tray opposite the incisors when the assembly is disposed in the wearer's mouth, in an orientation such that the short section is posterior of the tray and projects toward the wearer's mandible.

In other, more detailed features of the invention, the mouthpiece assembly further includes a platform configured to be optionally secured to the maxillary tray in place of the L-shaped hook. Preferably, but not necessarily, the platform and the L-shaped hook are different components. In addition, the maxillary tray can define a recess oriented along a posterior/anterior axis, for receiving either the platform or the L-shaped hook. The recess can include undercut sidewalls, and the platform and the L-shaped hook each have sidewalls configured to slidably engage, and be retained by, such sidewalls.

In other more detailed features of the invention, the prefabricated maxillary tray has a front wall, a rear wall, and a bottom wall that, together, define the channel, and the channel has a generally U-shaped cross-section. When the maxillary tray is disposed over the wearer's maxillary incisors, its front wall is disposed adjacent to the incisors' anterior surfaces and its rear wall is disposed adjacent to the incisors' posterior surfaces. In addition, the long section of the L-shaped hook is configured to be optionally secured to the surface of the maxillary tray's bottom wall opposite the incisors when the assembly is disposed in the wearer's mouth.

In yet other more detailed features of the invention, the mouthpiece assembly further includes a prefabricated mandibular tray defining a channel sized and configured to fit over at least the wearer's mandibular incisors. An additional quantity of adaptable material is disposed within the mandibular tray's channel and adapted to conform to the shape of the wearer's mandibular incisors, to assist in retaining the assembly within the wearer's mouth. The mandibular tray is configured to engage the L-shaped hook. The hook is configured such that, when it is secured to the maxillary tray, its short section is engageable with the mandibular tray, to limit retrusion of the mandible.

The prefabricated mandibular tray preferably includes a rear wall and a top wall that, together, define the mandibular tray's channel. When the mandibular tray is disposed over the wearer's mandibular incisors, its rear wall is disposed adjacent to the incisors' posterior surfaces. The portion of the mandibular tray that is engageable with the hook is the tray's rear wall, and it has a height that is greater than the portions of the mandibular tray's rear wall that are not engageable with the hook. Preferably, the portion of the mandibular tray that is engageable with the hook has a generally L-shaped cross-section, whereas the portions of the mandibular tray that are not engageable with the hook further include a front wall, and such portions have a generally U-shaped cross-section.

In one optional feature of the invention, the maxillary tray further is configured to extend over the maxillary canine teeth, and the front wall of the maxillary tray is configured to include a left stop and a right stop. In addition, the mandibular tray further is configured to extend over the mandibular canine teeth, and the mandibular tray further includes a left fin and a right fin that are engageable with the respective left and right stops of the maxillary tray, to limit retrusion of the mandible. Preferably, the portions of the mandibular tray that are not engageable with the hook further include a front wall, and the left and right fins are secured to the front wall of the mandibular tray and project upwardly therefrom.

In a separate and independent feature of the invention, the mouthpiece assembly is configured to adjustably accommodate to users having a variety of arch sizes and shapes. To this end, the assembly includes a prefabricated tray defining a channel sized and configured to fit over at least the user's maxillary or mandibular incisors, and the tray includes a plurality of hinges that allow the tray's curvature to be selectively adjusted so as to accommodate to users having a variety of arch sizes and shapes. A quantity of adaptable material is disposed within the tray's channel and adapted to conform to the shape of the user's maxillary or mandibular incisors, to assist in retaining the assembly within the user's mouth. Either or both of the maxillary tray and the mandibular tray, described above, can incorporate this feature of the invention.

The prefabricated tray can include a front wall, a rear wall, and an interconnecting top or bottom wall. Together, the walls define the tray's channel. Portions of the channel have a generally U-shaped cross-section. When the tray is disposed over the user's maxillary or mandibular incisors, the front wall is disposed adjacent to the incisors' anterior surfaces and the rear wall is disposed adjacent to the incisors' posterior surfaces.

The plurality of hinges can include first and second hinges in the respective left and right sides of the tray's rear wall. In addition, the plurality can further include third and fourth hinges in the respective left and right sides of the tray's front wall. The tray's first and second hinges can be formed by aligned gaps in the tray's front and top/bottom walls, and the tray's third and fourth hinges is formed by aligned gaps in the tray's rear and top/bottom walls. The adaptable material can be disposed in the aligned gaps formed in the tray's front and top/bottom walls.

Other features and advantages of the invention will become apparent from the following description of the preferred embodiments, taken in conjunction with the illustrative drawings, which depict, by way of example, the principles of the invention.

### BRIEF DESCRIPTION OF THE DRAWINGS

FIG. 1 is an exploded, lower front isometric view of a portion of a maxillary intraoral appliance in accordance with the invention, for selective use as a discluder for diagnosing and treating bruxism, tension headaches, and common migraine headaches, and/or as a mandibular advancement device for diagnosing and treating mild to moderate obstructive sleep apnea.

FIG. 2A is a front elevational view of the maxillary appliance of FIG. 1, including an attached optional platform, and a mating mandibular appliance. In this configuration, the appliances are useful in diagnosing and treating bruxism, tension headaches, and common migraine headaches. The appliances are shown in spaced apart relationship to each other.

FIG. 2B is a front elevational view of the maxillary and mandibular appliances of FIG. 2A, but shown with the mandibular appliance elevated into direct engagement with the maxillary appliance's platform.

FIG. 3A is a front elevational view of the maxillary appliance of FIG. 1, including an attached optional hook, and a mating mandibular appliance. In this configuration, the appliances are useful in diagnosing and treating mild to moderate obstructive sleep apnea. The appliances are shown in spaced apart relationship to each other.

FIG. 3B is a front elevational view of the maxillary and mandibular appliances of FIG. 3A, but shown with the mandibular appliance elevated into direct engagement with the maxillary appliance's hook.

FIG. 4 is an upper rear isometric view of the maxillary and mandibular appliances of FIG. 3B, disposed in their operative relationship relative to each other but outside the wearer's mouth and awaiting deposit of adaptable material into their respective arcuate channels.

FIGS. 5A, 5B and 5C are bottom plan views of the tray portion of the mandibular appliance, showing three selected positions of the tray's hinges, for configuring the tray into curvatures matching the arch shapes of three different exemplary wearers.

FIG. 6A is an upper front isometric view of the tray portion of the mandibular appliance, disposed over a wearer's mandibular arch as it is being adjusted to match the size and shape of the wearer's arch.

FIG. 6B is an upper front isometric view of the mandibular tray of FIG. 6A, but now with a quantity of adaptable material disposed within it for conforming engagement with the wearer's mandibular arch.

FIGS. 7A, 7B and 7C are side sectional views of the maxillary and mandibular appliances of FIG. 3B, shown in their fully assembled and installed positions on a wearer's respective maxillary and mandibular arches, the views being taken along a central posterior/anterior axis. FIG. 7A shows the wearer's mandible in a lowered and fully retrusive position; FIG. 7B shows the mandible in an elevated position, with the retrusion of the mandible being limited by engagement of the maxillary assembly's hook with the mandibular assembly's tray; and FIG. 7C shows the mandible in its fully protrusive position.

FIGS. 8A and 8B are front elevational views similar to FIGS. 2A and 2B, but including an alternative embodiment of a mandibular appliance, this embodiment including upward-projecting left and right fins for engaging stops formed in the maxillary appliance, to prevent excessive retrusion of the mandible.

### DETAILED DESCRIPTION OF THE PREFERRED EMBODIMENTS

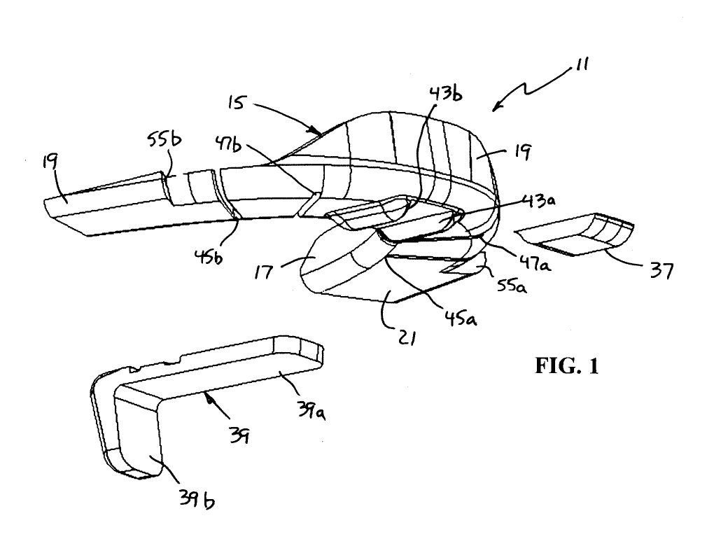

With reference now to the illustrative drawings, and particularly to FIGS. 1-4, there is shown an embodiment of an intraoral assembly for use in diagnosing and treating a variety of termporomandibular disorders. The assembly is optionally configurable for use as an intraoral discluder, for diagnosing and treating wearers suffering from bruxism, tension headaches, and common migraine headaches, by preventing contact between opposing canine and posterior teeth and thereby reducing the intensity of clenching of the wearer's temporalis muscles. Alternatively, the assembly is optionally configurable for use as a mandibular advancement device, for diagnosing and treating wearers suffering from obstructive sleep apnea by preventing excessive retrusion of the wearer's mandible. In both cases, the assembly can be readily adjusted to accommodate wearers whose maxillary and mandibular arches have a variety of sizes and shapes. The assembly includes both a maxillary appliance 11 sized and configured to engage and be retained on a wearer's maxillary arch and a mandibular appliance 13 sized and configured to engage and be retained on the wearer's mandibular arch.

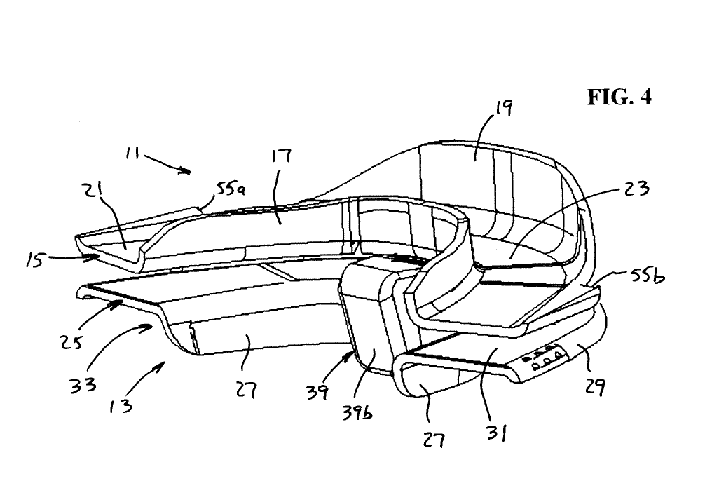

With particular reference to FIGS. 1 and 4, the maxillary appliance 11 is shown to include an arcuate tray 15 formed by a rear wall 17, a front wall 19, and a bottom wall 21. The three walls, together, form an arcuate channel 23 having a generally U-shaped cross-section. The channel is sized and configured to fit over, and to be retained by, the wearer's maxillary arch. In its installed position on the wearer's maxillary arch, the tray's front wall is disposed adjacent to the arch's anterior surfaces and the tray's rear wall is disposed adjacent to its posterior surfaces. The channel extends over at least the maxillary incisors, and preferably also over the maxillary canine teeth and at least some of the posterior maxillary teeth. Any excess length can be trimmed.

The mandibular appliance 13 similarly includes an arcuate tray 25 formed by a rear wall 27, a front wall 29, and a top wall 31. The three walls, together, form an arcuate channel 33 having a generally U-shaped cross-section. The channel is sized and configured to fit over, and to be retained by, the wearer's mandibular arch. In its installed position on the wearer's mandibular arch, the tray's front wall is disposed adjacent to the arch's anterior surfaces and the tray's rear wall is disposed adjacent to its posterior surfaces. The channel extends over at least the mandibular incisors, and preferably also over the mandibular canine teeth and at least some of the posterior mandibular teeth. Any excess length can be trimmed.

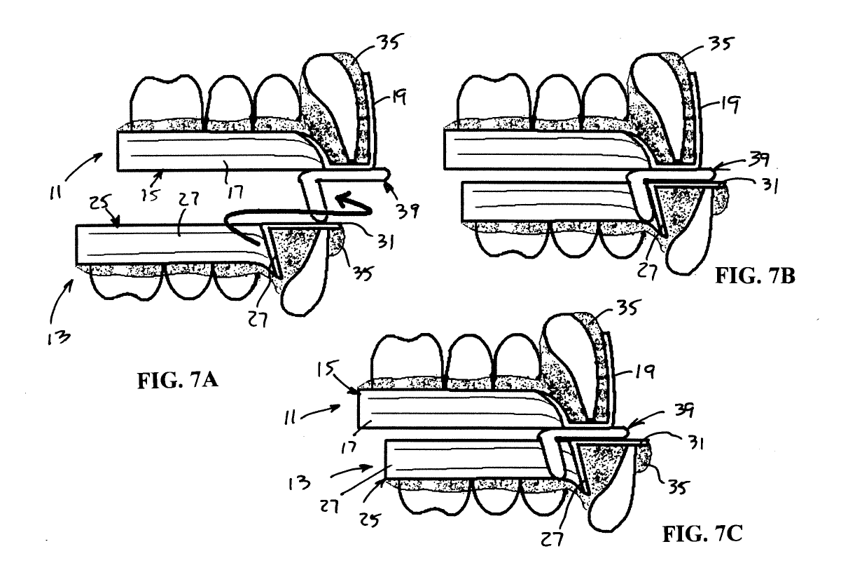

A quantity of adaptable material 35 (FIG. 7) preferably is disposed within both the channel 23 of the maxillary tray 15 and the channel 33 of the mandibular tray 25, along their entire lengths. This material allows the appliances to conformable engage the wearer's teeth and thereby enhance their retention within the mouth. The adaptable material may include any conventional type of material that conforms to the teeth and retains its shape, including, for example, silicone resins, polymers, enamels, rubbers, and any other material known to be used by dental practitioners for similar applications.

As shown in FIG. 1, the maxillary appliance 11 further includes a platform 37 and an L-shaped hook 39 that optionally can be attached, alternatively, to the maxillary tray 15. To that end, the maxillary tray includes a central recess 41 in the lower surface of its bottom wall 21, along a central anterior/posterior axis. The recess is defined by undercut sidewalls 43a and 43b. The platform and the L-shaped hook both include sloped sidewalls sized and shaped to allow these components to be slidably positioned in the recess. The L-shaped hook 39 includes a long segment 39a and a short segment 39b projecting laterally from one end of the long segment.

When the platform 37 is positioned in the recess 41 of the maxillary appliance 11, the appliance can function as a discluder, for diagnosing and treating wearers suffering from bruxism, tension headaches, and common migraine headaches. It achieves these functions by preventing contact between opposing canine and posterior teeth and thereby reducing the intensity of clenching of the wearer's temporalis muscles. Alternatively, when the L-shaped hook 39 is positioned in the recess, the appliance can function as a mandibular advancement device, for diagnosing and treating wearer's suffering from obstructive sleep apnea. It achieves these functions by preventing excessive retrusion of the wearer's mandible. In each case, the platform and the hook are retained in a selected position in the recess by a suitable dental adhesive material.

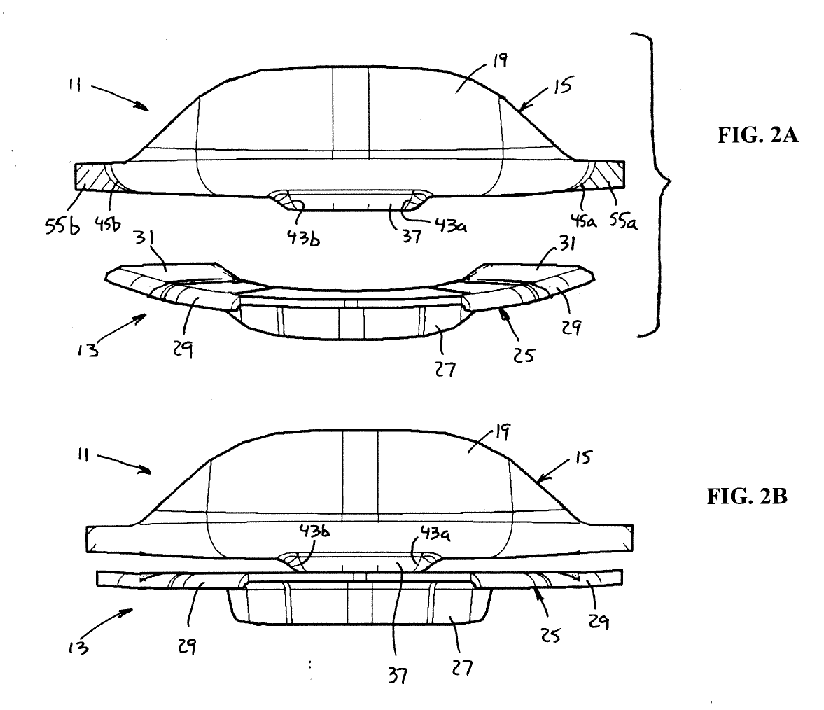

FIGS. 2A and 2B show the maxillary appliance 11 of FIG. 1 with the platform 37 disposed in its position within the recess 41. The complementary mandibular appliance 13 also is shown. Both appliances are shown outside a wearer's mouth, and prior to the deposit of any adaptable material into their channels 23, 33. In FIG. 2A, the mandibular appliance is disposed in spaced relationship to the maxillary appliance, whereas in FIG. 2B, the mandibular appliance is elevated into direct engagement with the maxillary appliance, with the tray 25 of the mandibular appliance 13 contacting the platform 37 of the maxillary appliance 11. This engagement with the platform effectively prevents contact between opposing upper and lower teeth, including the canine and posterior teeth, and thereby reduces the intensity of clenching of the wearer's temporalis muscles.

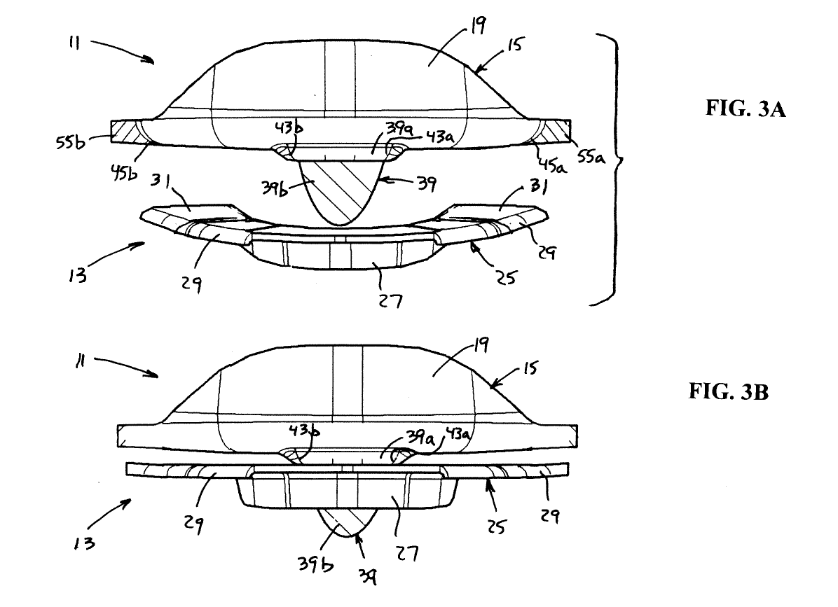

FIGS. 3A and 3B show the maxillary appliance 11 of FIG. 1 with the L-shaped hook 39 disposed in its position within the recess 41. The complementary mandibular appliance 13 also is shown. Both appliances are shown outside a wearer's mouth, and prior to the deposit of any adaptable material into their channels 23, 33. In FIG. 3A, the mandibular appliance is disposed in spaced relationship to the maxillary appliance, whereas in FIG. 3B, the mandibular appliance is elevated into direct engagement with the maxillary appliance, with the tray 25 of the mandibular appliance engaging the L-shaped hook 39 of the maxillary appliance. This engagement with the hook effectively prevents the wearer's mandible from moving to its fully retrusive position, where the wearer's airway can be obstructed and sometimes even closed off entirely.

In the configuration shown in FIGS. 3A and 3B, with the L-shaped hook 39 disposed in the recess 41 in the bottom wall 21 of the maxillary tray 15, the hook is slidably positioned within the recess such that the retrusion of the wearer's mandible is limited to a specific position. The position is selected to allow an optimum amount of movement of the wearer's mandible without allowing the airway to be unduly obstructed.

In an alternative, less preferred form of the invention, the maxillary appliance 11 could be used by itself, without a mating mandibular appliance 13. In that case, the platform 37 or the L-shaped hook 39 would directly engage the mandibular incisors. In another alternative, less preferred form of the invention, the platform could be constructed simply by removing the short segment from the L-shaped hook.

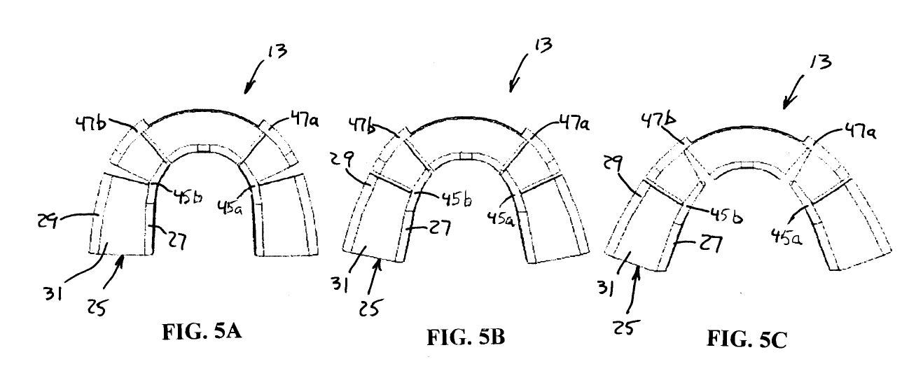

FIGS. 5A, 5B and 5C are bottom plan views of the mandibular tray 25, showing how it can be manually configured to match the size and shape of the mandibular arches of a wide variety of wearers. For that purpose, the tray includes first and second hinges 45a and 45b in the respective left and right sides of its rear wall 27, and it further includes third and fourth hinges 47a and 47b in the respective left and right sides of its front wall 29. The two rear wall hinges (45a, 45b) each are formed by aligned gaps in the adjacent top wall 31 and front wall 29. Similarly, the two front wall hinges (47a, 47b) each are formed by aligned gaps in the adjacent top wall 31 and rear wall 27. The tray 25 is formed of conventional dental materials such as acrylic or polycarbonate, which have sufficient flexibility to allows the hinges to be readily opened and closed.

The hinges 45a, 45b, 47a and 47b function by allowing the rear wall 27 or the front wall 29 to pivot and thereby open up the gap in the adjacent top wall 31. FIG. 5A shows the tray 25 adjusted to a shape matching that of a wearer having a somewhat narrow arch. In this configuration, the rear wall hinges 45a, 45b are opened and the front wall hinges 47a, 47b are substantially closed. FIG. 5B shows the tray adjusted to a shape matching that of a wearer having a large, but normally shaped mandibular arch. In this configuration, the rear wall hinges 45a, 45b and the front wall hinges 47a, 47b all are slightly opened. FIG. 5C shows the tray adjusted to a shaped matching that of a wearer having a wide, divergent mandibular arch. In this configuration, the rear wall hinges 45a, 45b and the front wall hinges 47a, 47b all are opened substantially.

Providing hinges on both the rear wall 27 and the front wall 29 of the mandibular tray 25 allows the shape of the tray to be adjusted to accommodate the arch shapes and sizes of substantially all potential wearers. In addition, the tray's channel 33 has sufficient width to accommodate additional variations in arch shape, and well as minor misalignments of the teeth.

Although not shown in the same detail in the drawings, the maxillary tray 15 includes a similar set of hinges in its rear wall 17 and front wall 19. Rear wall hinges 49a, 49b and front wall hinges 51a, 51b are observable in FIGS. 1 and 4.

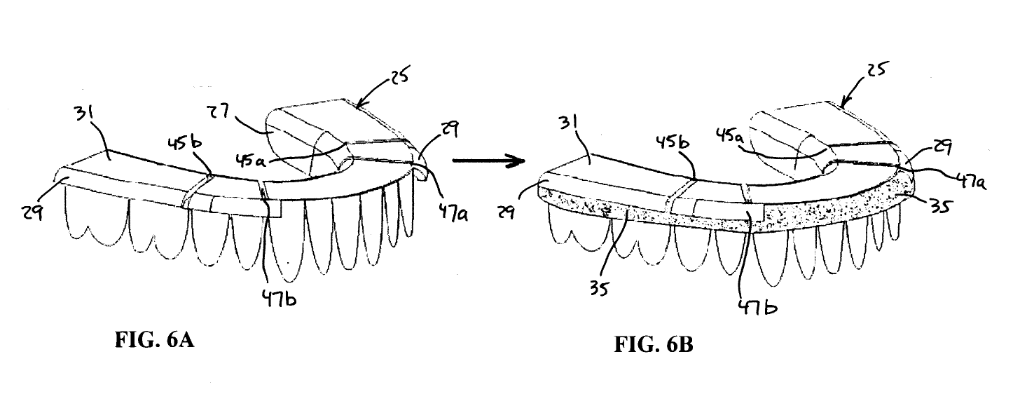

FIG. 6A shows the mandibular tray 25 positioned over a wearer's mandibular arch as it is being adjusted to conform to the size and shape of the arch. In this example, the hinges 45a, 45b, 47a and 47b all are observed to be slightly opened. Thereafter, as shown in FIG. 6B, the adaptable material 35 has been deposited into the tray's channel 33 (FIG. 4), and the appliance again is positioned over the wearer's mandibular arch. It is noted that some of the adaptable material migrates into the gaps formed in the tray's top wall. Preferably, sufficient adaptable material is used to substantially fill the channel. Any excess material displaced when the appliance is positioned over the wearer's arch can be readily removed after the material has hardened.

The mandibular appliance 13 is held in position on the mandibular arch until the adaptable material has set or polymerized sufficiently to retain a shape that conforms to the individual teeth, but remains sufficiently resilient to allow the appliance to be readily removed. Repeatedly removing and replacing the appliance on the arch several times ensures that the adaptable material acquires an optimal, non-binding shape that allows the appliance to be retained in place while at the same time allows it to be readily removed. Dental practitioners generally are familiar with this procedure.

FIGS. 7A, 7B and 7C are cross-sectional views of the both maxillary appliance 11 and the mandibular appliance 13, in their prescribed positions in the wearer's mouth, taken along a central posterior/anterior axis passing through the wearer's incisors. The L-shaped hook 39 is included in the depicted maxillary appliance. The figures show the allowed range of motion for the wearer's mandible, with mandible retrusion being limited by engagement between the short segment 39b of the L-shaped hook with the rear wall 27 of the mandibular tray 25. Specifically, FIG. 7A shows the wearer's mandible in a lowered and fully retrusive position; FIG. 7B shows the mandible in an elevated position, with the retrusion of the mandible being limited by engagement of the maxillary appliance's hook with the mandibular appliance's tray; and FIG. 7C shows the mandible in its fully protrusive position.

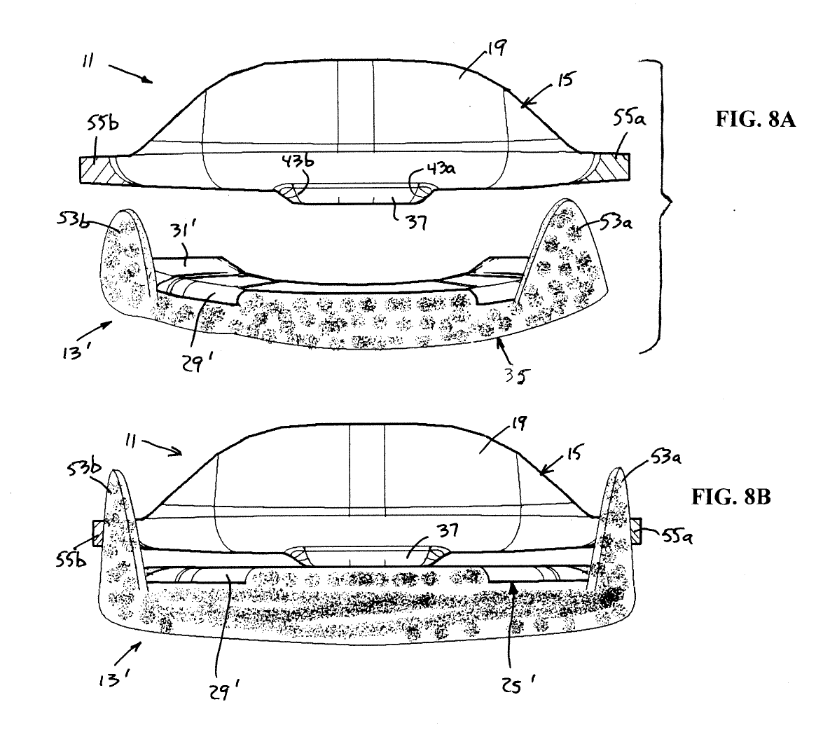

Finally, FIGS. 8A and 8B depict an alternative embodiment of a mandibular appliance 13′ in accordance with the invention, suitable for use with the same maxillary appliance 11 as is depicted in FIGS. 1-4. In this embodiment, the mandibular appliance 13′ includes a tray 25′ that supports left and right fins 53a and 53b, respectively, projecting upward from the left and right sides of the tray's front wall 29′. These fins are configured to abut against stops 55a and 55b, respectively, formed in the front wall 19 of the maxillary appliance's tray 15. This inhibits excessive mandible retrusion and thereby can function to diagnose and treat wearers suffering from obstructive sleep apnea. The maxillary appliance 11 can incorporate either the platform 37 or the L-shaped hook 39. In the latter case, the L-shaped hook and the stops function cooperatively to prevent excessive mandible retrusion.

The fins 53a, 53b can be formed in any of several suitable approaches. In one approach, the fins are preformed and secured in prescribed positions on the front wall of the mandibular tray using a suitable dental adhesive. In another approach, depicted in FIGS. 8A and 8B, the fins are manually formed using the same adaptable material as is used within the tray's channel 33′.

It should be appreciated from the foregoing description that the invention provides an improved intraoral assembly for use in diagnosing and treating a variety of termporomandibular disorders. The assembly is optionally configurable for use as a discluder, for diagnosing and treating wearers suffering from bruxism, tension headaches, and common migraine headaches, by preventing contact between opposing canine and posterior teeth and thereby reducing the intensity of clenching of the wearer's temporalis muscles. Alternatively, the assembly is optionally configurable for use as a mandibular advancement device, for diagnosing and treating wearers suffering from obstructive sleep apnea by preventing excessive retrusion of the wearer's mandible. In both cases, the assembly can be readily adjusted to accommodate wearers whose maxillary and mandibular arches have a variety of sizes and shapes.

Although the invention has been described in detail with reference only to the presently preferred embodiments, those skilled in the art will appreciate that various modifications can be made without departing from the invention. Accordingly, the invention is defined only by reference to the following claims.

I claim:

1. A mouthpiece assembly comprising:
a prefabricated maxillary tray defining a channel sized and configured to fit over at least the maxillary incisors of a wearer;
a quantity of adaptable material disposed within the tray's channel and adapted to conform to the shape of the wearer's maxillary incisors, to assist in retaining the assembly within the wearer's mouth; and
an L-shaped hook having a long section and a short section projecting laterally from one end of the long section, wherein the long section is configured to be optionally secured to the surface of the tray opposite the incisors when the assembly is disposed in the wearer's mouth, in an orientation such that the short section is posterior of the tray and projects toward the wearer's mandible.

2. The mouthpiece assembly as defined in claim 1, and further comprising a platform configured to be optionally secured to the surface of the maxillary tray opposite the incisors when the assembly is disposed in the wearer's mouth, wherein only one of the platform and the L-shaped hook can be secured to the maxillary tray at a time.

3. The mouthpiece assembly as defined in claim 2, wherein the platform and the L-shaped hook are different components.

4. The mouthpiece assembly as defined in claim 2, wherein:
the portion of the maxillary tray that is disposed opposite the incisors when the assembly is disposed in the wearer's mouth defines a recess oriented along a posterior/anterior axis; and
the platform and the L-shaped hook each are configured to fit within the recess.

5. The mouthpiece assembly as defined in claim 4, wherein:
the recess includes undercut sidewalls; and
the platform and the L-shaped hook each have sidewalls configured to slidably engage, and be retained by, the recess's undercut sidewalls.

6. The mouthpiece assembly as defined in claim 1, wherein:
the prefabricated maxillary tray has a front wall, a rear wall, and a bottom wall that, together, define the channel;
the channel has a generally U-shaped cross-section;
when the maxillary tray is disposed over the wearer's maxillary incisors, its front wall is disposed adjacent to the incisors' anterior surfaces and its rear wall is disposed adjacent to the incisors' posterior surfaces; and
the long section of the L-shaped hook is configured to be optionally secured to the surface of the maxillary tray's bottom wall opposite the incisors when the assembly is disposed in the wearer's mouth.

7. The mouthpiece assembly as defined in claim 1, and further comprising:
a prefabricated mandibular tray defining a channel sized and configured to fit over at least the wearer's mandibular incisors; and
an additional quantity of adaptable material disposed within the mandibular tray's channel and adapted to conform to the shape of the wearer's mandibular incisors, to assist in retaining the assembly within the wearer's mouth;
wherein the mandibular tray is configured to engage the L-shaped hook.

8. The mouthpiece assembly as defined in claim 7, wherein the hook is configured such that, when it is secured to the maxillary tray, its short section is engageable with the mandibular tray, to limit retrusion of the mandible.

9. The mouthpiece assembly as defined in claim 8, wherein:
the prefabricated mandibular tray has a rear wall and a top wall that, together, define the mandibular tray's channel;
when the mandibular tray is disposed over the wearer's mandibular incisors, its rear wall is disposed adjacent to the incisors' posterior surfaces; and
the portion of the mandibular tray that is engageable with the hook is the tray's rear wall, and it has a height that is greater than the portions of the mandibular tray's rear wall that are not engageable with the hook.

10. The mouthpiece assembly as defined in claim 9, wherein:
the portion of the mandibular tray that is engageable with the hook has a generally L-shaped cross-section; and
the portions of the mandibular tray that are not engageable with the hook further include a front wall, and such portions have a generally U-shaped cross-section.

11. The mouthpiece assembly as defined in claim 7, wherein:
the maxillary tray further is configured to extend over the maxillary canine teeth, and the front wall of the maxillary tray is configured to include a left stop and a right stop;
the mandibular tray further is configured to extend over the mandibular canine teeth; and
the mandibular tray further includes a left fin and a right fin that are engageable with the respective left and right stops of the maxillary tray, to limit retrusion of the mandible.

12. The mouthpiece assembly as defined in claim 11, wherein:
the portions of the mandibular tray that are not engageable with the hook further include a front wall; and
the left and right fins are secured to the front wall of the mandibular tray and project upwardly therefrom.

13. The mouthpiece assembly as defined in claim 7, wherein:
the maxillary tray includes a plurality of hinges that allow the maxillary tray's curvature to be selectively adjusted; and
the mandibular tray includes a plurality of hinges that allow the mandibular tray's curvature to be selectively adjusted.

14. The mouthpiece assembly as defined in claim 13, wherein:
the prefabricated maxillary tray has a front wall, a rear wall, and a bottom wall that, together, define the maxillary tray's channel;
the plurality of hinges of the maxillary tray include first and second hinges in the respective left and right sides of the maxillary tray's rear wall;
the prefabricated mandibular tray has a front wall, a rear wall, and a top wall that, together, define the mandibular tray's channel; and
the plurality of hinges of the mandibular tray include first and second hinges in the respective left and right sides of the mandibular tray's rear wall.

15. The mouthpiece assembly as defined in claim 14, wherein:
the plurality of hinges of the maxillary tray further include third and fourth hinges in the respective left and right sides of the maxillary tray's front wall; and
the plurality of hinges of the mandibular tray further include third and fourth hinges in the respective left and right sides of the mandibular tray's front wall.

16. The mouthpiece assembly as defined in claim 15, wherein:
each of the maxillary tray's first and second hinges is formed by aligned gaps in the maxillary tray's front and bottom walls;
each of the maxillary tray's third and fourth hinges is formed by aligned gaps in the maxillary tray's rear and bottom walls;
each of the mandibular tray's first and second hinges is formed by aligned gaps in the mandibular tray's front and bottom walls; and
each of the mandibular tray's third and fourth hinges is formed by aligned gaps in the mandibular tray's rear and bottom walls.

17. The mouthpiece assembly as defined in claim 14, wherein:
each of the maxillary tray's first and second hinges is formed by aligned gaps in the maxillary tray's front and bottom walls; and
each of the mandibular tray's first and second hinges is formed by aligned gaps in the mandibular tray's front and bottom walls.

18. An mouthpiece assembly configured to adjustably accommodate to users having a variety of arch sizes and shapes, the assembly comprising:
a prefabricated tray defining a channel sized and configured to fit over at least the user's maxillary or mandibular incisors;
wherein the tray includes a plurality of hinges that allow the tray's curvature to be selectively adjusted so as to accommodate to users having a variety of arch sizes and shapes; and
a quantity of adaptable material disposed within the tray's channel and adapted to conform to the shape of the user's maxillary or mandibular incisors, to assist in retaining the assembly within the user's mouth.

19. The mouthpiece assembly as defined in claim 18, wherein:
the prefabricated tray includes a front wall, a rear wall, and a top/bottom wall that, together, define the channel;
portions of the channel have a generally U-shaped cross-section; and
when the tray is disposed over the user's maxillary or mandibular incisors, the front wall is disposed adjacent to the incisors' anterior surfaces and the rear wall is disposed adjacent to the incisors' posterior surfaces.

20. The mouthpiece assembly as defined in claim 19, wherein the plurality of hinges include first and second hinges in the respective left and right sides of the tray's rear wall.

21. The mouthpiece assembly as defined in claim 20, wherein the plurality of hinges of the tray further include third and fourth hinges in the respective left and right sides of the tray's front wall.

22. The mouthpiece assembly as defined in claim 21, wherein:
each of the tray's first and second hinges is formed by aligned gaps in the tray's front and top/bottom walls; and
each of the tray's third and fourth hinges is formed by aligned gaps in the tray's rear and top/bottom walls.

23. The mouthpiece assembly as defined in claim 20, wherein each of the tray's first and second hinges is formed by aligned gaps in the tray's front and top/bottom walls.

24. The mouthpiece assembly as defined in claim 23, wherein the quantity of adaptable material further is disposed in the aligned gaps formed in the tray's front and top/bottom walls.
